(19) United States
(12) Patent Application Publication
(10) Pub. No.: US 2007/0043720 A1
(43) Pub. Date: Feb. 22, 2007

(54) System, apparatus and methods for storage, retrieval and exchange of personal profile data enabling consistent interpretation across multiple device, applications and data services

(75) Inventors: Nicholas Koenig, Watsonville, CA (US); Stuart Cudlitz, New York, NY (US); Eric Gregory, Larkspur, CA (US)

Correspondence Address: MORRISON & FOERSTER LLP, 425 MARKET STREET, SAN FRANCISCO, CA, 94105-2482, US

(73) Assignee: Soulware, Inc., Watsonville, CA (US)

(21) Appl. No.: 11/504,471

(22) Filed: Aug. 14, 2006

Related U.S. Application Data
(60) Provisional application No. 60/709,957, filed on Aug. 18, 2005.

(51) Int. Cl. G06F 17/30

(52) U.S. Cl. 707/6

(57) ABSTRACT

System, methods, and apparatus are disclosed for the improved use and maintenance of electronic user profiles. Profile entries reflect personal user information comprising a user action and associated circumstance (result) of that action. Action and circumstance information in the profile preferably includes a semantic reference value that improves usability of profile information across various devices, applications, data services, and the like.

### CROSS-REFERENCE TO RELATED APPLICATION

This application claims the benefit of U.S. Provisional Application No. 60/709,957, filed Aug. 18, 2005, which is hereby incorporated by reference in its entirety.

### BACKGROUND OF THE INVENTION

Advances in microelectronics in recent decades has led to an increasing number of intelligent devices. Moreover, these devices are increasingly able to communicate with other devices, often over wireless links. High levels of functionality are achieved where some portion of the intelligence of the device is dedicated to customize its operations to the needs and preferences of its particular user. Often the device relies on a user profile to record the choices, needs, preferences, habits, and characteristics of the particular user. These user profiles are typically proprietary in design and poorly suited for sharing user information with other devices.

A higher level of functionality, interoperability, and perceived user value for each device would be possible where the intelligent device can share profile-information with other intelligent devices or applications that service the same user.

Accordingly, there is a need in the art for improved user profile processing to facilitate the sharing of user profile data between and among a wide range of disparate devices and applications from a potentially wide range of different manufacturers and suppliers.

### BRIEF SUMMARY OF THE INVENTION

The invention is directed to methods and apparatus in an electronic data processing system including processing logic for storing, retrieving, and exchanging personal profile information including possibly user identity, user activity, activity result, and user preference data, in such a manner that enable the data to be shared with consistent interpretation, across multiple devices, applications, and services.

In one aspect of the invention, apparatus provides processing logic for accessing a local profile data store, for interfacing with one or more application agents, and for receiving a profile information request via the interfacing logic and accordingly exercising the accessing logic to satisfy the request, in part, by accessing profile data comprised of a concept identifier referencable to a semantic database.

In another aspect of the invention, methods are provided to build a user profile database that include storing instances of user identity information, activity information, circumstance (result) information, and associating each of the above together into a profile entry wherein at least one information instance includes concept identifier information referencable to a semantic database.

These and other inventive aspects will become clear by a review of the drawings, written description, and claims that follow.

### BRIEF DESCRIPTION OF THE DRAWINGS

FIG. 1 is a block diagram of one exemplary device employing aspects of the present invention.

FIG. 2 is a table showing the arrangement of social complexity values as used in one embodiment.

FIG. 3 illustrates one embodiment of a database structure capable of supporting persistent storage of user profiles.

FIG. 4 depicts one possible listing of computer code for implementing the database structure of FIG. 3.

FIG. 5 is a flowchart depicting the query request handling operation of the profiling kernel in one embodiment.

FIG. 6 is a flowchart depicting the modification request operation of the profiling kernel in one embodiment.

FIG. 7 is a flowchart depicting the local request handling operation of the profile exchange manager in one embodiment.

FIG. 8 is a flowchart depicting the remote request handling operation of the profile exchange manager in one embodiment.

### DETAILED DESCRIPTION

Overview

A system employing aspects of the invention may be comprised of one or more data processing devices, each preferably capable of executing stored programs, storing and retrieving data, receiving input data from a user (input), displaying data to the user (output), and communicating with other data processing devices, for example, via Internet protocols (TCP/IP networking). The processing logic for a device may be implemented preferably as software directing the execution of computing hardware, or as a programmable logic device such as an FPGA, a hardwired hardware device such as an ASIC, another data processing mechanism, or a combination. The preferred embodiment implements processing logic as software directing hardware. The descriptions that follow will be discussed as such an implementation recognizing that the invention is not intended to be so limited. One advantage of software-based embodiments is the ease of upgrades and maintenance.

Stored within each device is processing logic (profiling kernel), such as a software program that directs the operation of computing hardware, and a persistent data store that maintains a profile of aggregate user behavior (profile, or profile data store). The profile may be based, for example, on user identity, activity, preference and performance data. The profile is implemented as a collection of standardized samples of behavior. The samples are indexed using a set of pre-defined “semantic tags” (Concept Identifiers) that each have a specific, well-defined, universally understood meaning. (The scope of the “universe” as used herein is the breadth of entities that recognize a common semantic authority such as the WordNet lexical database discussed below.) In addition to each concept being well defined, the relationships between concepts are well defined, and universally understood, according to a pre-defined semantic model. Basing the profile indices on semantic concepts, with universally defined relationships is one inventive aspect that allows building software programs (agents) that can cross-reference, or navigate within the profile, such that agent operation is advantageously adaptive to user needs, desires and preferences.

New samples are generated and added to the profile by preferably software-based agents that are explicitly programmed to do so. Agents may augment the profile by tracking and recording user actions automatically, without requiring explicit user interaction. In addition, agents may augment the profile as a result of direct and explicit user input and interaction. Over time, this process results in the creation of an aggregate personal profile, that enables agents to adapt their operations to the ever changing needs, desires and preferences of the user, without requiring constant, and redundant user input. For example, when updating a phone number of a family member in a computer-based address book, a cell phone and a PDA employing aspects of the present invention can easily learn of the change through the user profile, eliminating the need for manual updates to each of the devices.

To support the sharing of profile samples across devices, the profiling kernel acts as an intermediary, or broker for all requests for profile data on the local device. When a local agent makes a request for profile data in the preferred embodiment, the kernel first examines the locally stored profile for the requested data. If requested data is found locally, the requested data is retrieved and returned to the requesting agent. If the requested data is not found in the local data store, the request may be forwarded to the kernel running on another device. If no other device can satisfy the request, the request is rejected.

In one embodiment, the forwarding of requests to remote devices is enabled or disabled by the requesting agent. Each agent may direct the system kernel to a specific course of action, such as: a) not forward requests at all, b) only forward requests to specific remote devices, or c) forward requests to any dynamically discovered devices that may be able to satisfy the request. Some agents may specify the forwarding of requests to specific devices, in response to explicit user input, such as a URL. Others may be pre-programmed to forward requests to well known services (similar to the way the Search feature in web browsers know how to find Google, or how the iTunes music player software knows how to find the Apple Music Store). Alternatively, other agents may direct the system kernel to forward requests to any device that is dynamically discovered, in proximity to the requester, in a peer-to-peer fashion. This method of “distributed profile storage” provides a consistent and uniform method of accessing data, regardless of its physical location.

Implementation on a Laptop Computer

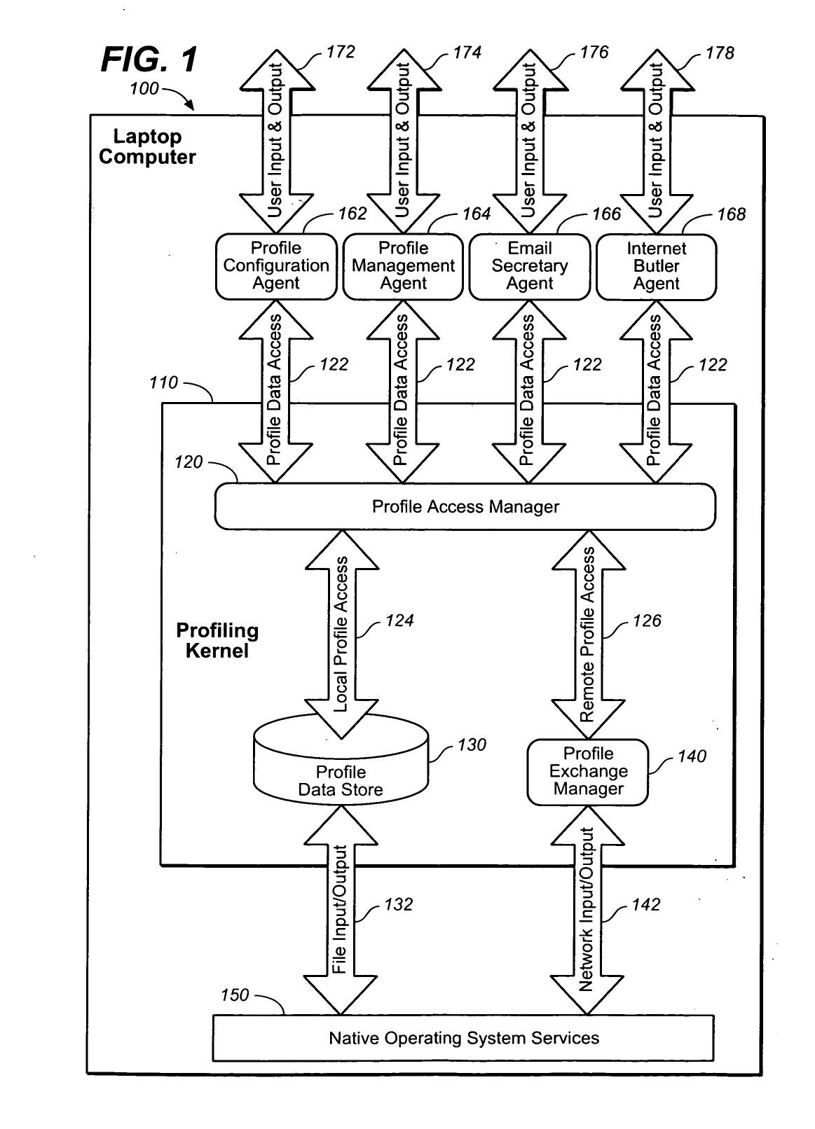

FIG. 1 is a block diagram of one exemplary device employing aspects of the present invention. A preferred embodiment of the invention 100 is described here in terms of an implementation using a typical laptop computer with wireless Internet connectivity. Such a laptop computer is understood to include a CPU, memory, a persistent storage device such as a hard disk, and a wireless network adapter. Software installed on this laptop includes a profiling kernel 110 and certain agents 162-168 programmed to access and store data as Profile Samples (profile entries) via the kernel. Agents shown for illustrative purposes in this embodiment include a Configuration Agent 162, a Management Agent 164, an Email Secretary 166, and an Internet Butler 168. These agents are illustrative in nature and none is specifically required to practice aspects of the invention. Other agents may, of course, exist in this or other embodiments, and may exist in broader forms or nature.

An “application agent” as used herein, implies processing logic external to the profiling kernel that requests to access a profile data store. That is to say, as used herein, the profiling kernel is the service provider to the application agent as service requester. And again, an application agent is processing logic that requests access to profile data. “Agent” is used herein synonymously with application agent.

Profiling Kernel 110 comprises profile access manager 120, profile data store processor 130, and profile exchange manager 140. Profile access manager 120 comprises processing logic to interface with clients of the profiling kernel 110 such as agents 162-168 as indicated by interface arrows 122. Profile access manager 120 further comprises processing logic to interface with profile data store processor 130 as indicated by interface arrow 124, and with profile exchange manager 140 as indicated by interface arrow 126. Profile data store processor 130 and profile exchange manager 140 each have corresponding processing logic to effect the interface with profile access manager 120. It is noted that the above-mentioned interfaces could be as simple as a jump or call to a subroutine existing in the same program or as complex as desired involving, for example, formalized, mediated, interfaces between separate programs or systems. Profile access manager 120 in this embodiment further comprises the processing logic to recognize the type of profile request being made over it service interface 122 (such as a request for existing profile data, or a request to create a new profile entry), and to exercise profile data store processor 130 via interface 124 to effect the access operations on the persistent profile data store that are indicated by the specific profile request received over the service interface 122.

Profile data store processor 130 comprises processing logic to access the contents of a persistent data-store having profile data. Such access may include, for example, reading and/or writing to add, change, or delete data. An access to profile information may involve any one or more of such access operation types. Profile data store processor 130 may operate on profile data it can directly access such as profile data in memory or memory-mapped storage, or on data it accesses indirectly by using, for example, the services of a data base management system or the native operating system 150 such as indicated by interface arrow 132. In the preferred embodiment, profile data store processor 130 accesses profile data in the persistent data store via an SQL-based, relational data base management system.

Profile exchange manager 140 comprises processing logic to initiate and conduct communications with other profiling kernels via network communications as indicated by interface arrow 142.

One skilled in the art recognizes that the profiling kernel elements of FIG. 1 are functional blocks the divisions between which are provided to help explain aspects of the invention. Such functional divisions may or may not correspond to organizational divisions in physical embodiments such as divisions between, e.g., lines of codes, software modules, disk files, or memory blocks.

Semantic References

Different agents in the illustrated embodiment may be developed independently, by various parties, with little to no knowledge of each other. In order for these agents to be able to interpret the same profile samples, and navigate or cross-reference them, there is a common and uniform definition of the indices and values.

The preferred embodiment of the system employs Concept Identifiers (ConceptIDs) that uniquely identify universal concepts and imply a structure of related concepts as defined, for example, in the Soulware Concept Database. The concepts defined in the Soulware Concept Database come from WordNet (http://www.cogsci.princeton.edu/˜wn/). The WordNet Reference Manual obtained from http://wordnet.princeton.edu/doc is provided herein as Appendix I. WordNet is a lexical database of concepts that occur in the English language, and semantic relationships between those concepts. The Soulware Concept Database assigns unique ConceptIDs to each concept in the WordNet database, for use as indices in Profile samples. The Soulware Concept Database is currently published online at http://www.protozoa.tv/sw. The SOulware Concept Database is one example of a referencable semantic database.

The specific data format for Concept IDs in this embodiment is a unique string of 8 characters. For example, the Concept ID for the notion of a persons “first name” is the string n0594654. (The definition of this concept and it's relationship to other concepts can be seen at: http:/www.protozoa.tv/sw/?Concept=1&Input=n0594654 and is herein provided as Appendix II.).

The use of concept identifiers referencable to a semantic database for indexing entries in a profile data store facilitates broader, cross-agent use of collected profile data. This represents an advantage of inventive aspects disclosed herein. Note that the concept identifiers need not, and often preferably are not, affirmatively referenced against a semantic database at runtime. The recognized semantic database for the operating universe may need only be referenced at the time of design of the particular application agent to align its relevant data items with more universally recognizable concept identifiers.

Static View

FIG. 1 provides a static view of the primary system components and how they relate to each other in one embodiment. The practice of various inventive aspects in this embodiment are illustrated using at least the components that make up the profiling kernel 110, including the Profile Access Manager 120, the Profile Data Store Processor 130, and the Profile Exchange Manager 140.

The various Agent components 162-168 described below are not required in every practice of the invention. They may enhance the utility and performance of the system by allowing the user more direct and explicit interaction with the operation of the system, by adjusting or correcting accumulated profile sample data to more accurately reflect user preference.

Agents

The Agents 162-168 are processing logic, here, the software programs directing execution of computing hardware, that directly interact with the user and perform operations on behalf of the user. The profiling kernel 110 enhances Agent operations, by providing a common mechanism and model for unified data storage and interpretation across various Agents in the system.

The system is not limited to any specific number or type of agents, other than the native memory and processing limitations of the data processing device itself. Additional agents are added to the system through the normal software distribution and installation utilities provided by the native operating system environment.

During the agent installation process in one embodiment, the agent adds specific information about itself to the profile that may include, for example, (i) identity entries for the manufacturer, developer, and/or vender of the agent, (ii) namespaces that the agent uses to identify itself, (iii) scopes that agent uses to classify, categorize, or partition its samples, and (iv) activities for which the agent will potentially create samples.

Over time, as a broader variety of agents are used, the Profile accumulates samples resulting from a broader set of user activities. The accumulated set of samples, along with the relationships between the concepts involved, create a base of knowledge about the user. Since agent operation and behavior is modified by what is discovered in this knowledge-base, the broader the knowledge, the greater the operation of the agents is enhanced.

The profile samples accumulated in a single Profile Data Store, may have originated from locally and/or remotely executing Agents. The knowledge acquired in the Profile of a single device is a result of activity across multiple Agents, possibly from remote devices.

An Agent's behavior may be advantageously guided by the results of profile queries. Queries may be satisfied by either local or remote profiles. The behavior of an Agent running on a single device is a result of accumulated knowledge across multiple Profiles, possibly from remote devices.

The illustrative implementation for laptop computer as depicted in FIG. 1 includes four specific agents that directly interact with the user. Configuration Agent 162 implements a user interface for basic maintenance of the Profile data related to the identity of the primary (and possibly additional) users of the system. For each user, these settings include Family Name (n0594614), First Name (n0594614), Nickname (n0594614), Birthday (n1439062), Mailing Address (n0797497), Telephone Number (n0602734), Email Address (n0589659), Title (n0594860), Organization (n0767052), and URL (n0596406).

Management Agent 164 implements a user interface for manually, and explicitly viewing, creating, deleting, and modifying data values stored in the profile samples. Each sample is preferably presented to the user as a set of editable fields in a form as is well understood in the art. The management agent is also responsible for managing the longer term storage of samples in the profile. On a periodic basis (daily, weekly, monthly), this agent scans the profile for expired samples (samples whose “expiration date” has passed), and presents the user with the option to purge expired samples. The user may accept or extend the lifespan of the samples by some period of time (the expiration date of the selected samples is updated).

Email Secretary Agent 166 prioritizes a user's incoming mail by cross-referencing the senders with upcoming items in the user's calendar. When an incoming message is from a person (or organization) with which an upcoming appointment or event is found, the user is preferably notified of this relationship, by a separate dialog box notification. For example, as the date of an upcoming business meeting approaches, email from another meeting attendee gets prioritized according to the proximity of the meeting, and triggers a reminder notice to be presented to the user. This dialog preferably also allows users to explicitly state the urgency, or importance of the relationship between this event and incoming email, such that subsequent email from that person would be prioritized and triggered accordingly.

Internet Butler Agent 168 implements a user interface for enhanced web searching by cross-referencing search results with the user's calendar, user preferences and behavior history in the profile. As the user responds by selecting from presented results, the profile is updated with entries reflecting the selection which, in turn, affect future information presented to the user. As such, the Internet Butler Agent 168 is the most complex use of the profiling kernel inventive aspects by an illustrative agent presented in this particular embodiment. The Internet Butler Agent enables, disables or directs the specific forwarding of user initialized Internet search both through the local device and through requests to remote devices. When enabling or specifying an Internet search through a remote device The Butler Agent directs the system kernel to forward search requests to well known services (such as Google). This agent also may forward requests to any device that is dynamically discovered, in proximity to the requestor, in a peer-to-peer fashion to broaden the search or locate previous results for the user's search keywords. The Internet Butler Agent then updates The Profile Data Store (PDS) with all relevant profile data in the local device.

In this way the Internet Butler Agent 168 complements and elaborates the value and function of the Email Secretary Agent. In the same example as above, as the date of an upcoming business meeting approaches, relevant Internet search results would also be prioritized according to the user's explicit search requests and preference settings, including fresh news or previous Internet postings related to the subject, date and participants of the upcoming meeting. The Internet Butler Agent may then preferably cross-reference these results with the results prioritized by the Email Secretary Agent that is sorting the incoming email.

Profile Data Store (PDS)

The Profile Data Store (PDS) is the data storage (database) for all profile data in the local device and is accessed by Profile Data Store Processor 130. A distinctive feature of this system is the machine usable representation and data model of user relevancy, which is achieved in the preferred embodiment through the use of universal concept IDs as the indexing keys over a database tracking user activity, results of that activity, and explicitly stated user preference.

Within this embodiment of the invention, the Profile Data Store is built using a relational database such as Oracle or MySQL, although no aspect of the invention requires this. Alternative storage mechanisms, preferably supporting efficient indexing and association, may be advantageously used (for example dbm [http://www.gnu.org/software/gdbm/gdbm.html]).

Within the Profile Data Store, user behavior is recorded as a set of Behavior samples, i.e., profile entries. Each sample in the preferred embodiment is composed of User Identity, Activity, Circumstance (result) and Preference.

User Identity information specifies the individual or organization performing the activity, typically the user.

Activity information in the preferred embodiment is used to index user behavior. An activity is represented in the profile as an association between a verb concept identifier in a semantic reference database such as the Soulware concept database, and a Social Complexity Value. Each agent defines the set of activities that it uses when creating new behavior samples. The set of activities used by an agent are added to the profile during installation of the agent software into the computer or device. It is expected that there may be overlap of specific Activities (verb/complexity pairs) across agents. An agent request for the addition of a new Activity (verb/complexity) entry into the profile, where an equivalent Activity with the same verb/complexity values already exists, is a valid request. However, only a single unique Activity entry with those values will result. All agents creating behavior samples for the same verb/complexity values, use the same Activity index in those samples. This provides one dimension of cross-referencing through the profile across agents.

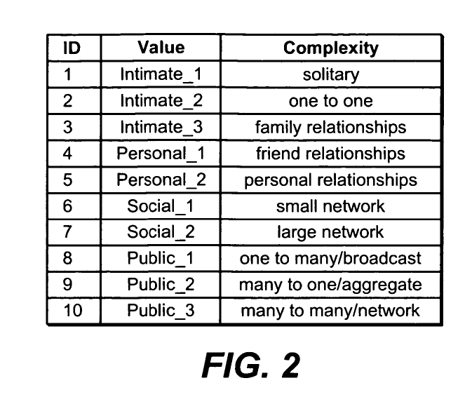

FIG. 2 is a table showing the arrangement of social complexity values as used in one embodiment. The range of possible social complexity values for the preferred embodiment are predefined and listed in the table of FIG. 2. The actual values used by each agent when specifying activities are determined by the functions provided by the agent. For example, the Email Secretary Agent design preferably uses a social complexity value of Intimate_1 when specifying the activity of responding to a personal email message. Alternatively, the activity of posting an email message to a public mailing list preferably uses a complexity value of Public_1.

Circumstance data in the user profile represents the outcome, result or measure of the user's participation or performance of an action or activity. Circumstantial data are preferably the measured or recorded values themselves. The set of recognized elements that can be tracked as circumstantial data in the preferred embodiment is specified by the set of nouns and adjectives in a reference semantic database, such as the Soulware concept database.

The Preference component of the profile allows the user to explicitly specify a preference, level of importance or “weighting” of specific entries in their profile. It provides a measure of specific relevancy or importance to the user. The weight value associated with a particular profile entry helps to distinguish it from other similar entries, by a measure of explicitly stated user relevance. By default, all samples are stored with a default ‘par’ value that neither enhances nor diminishes the relevance or importance of the data sample. The user may, at any time, edit the weight of a data sample, either increasing or decreasing its value, to establish the priority of that particular sample in comparison to other samples that are otherwise similar.

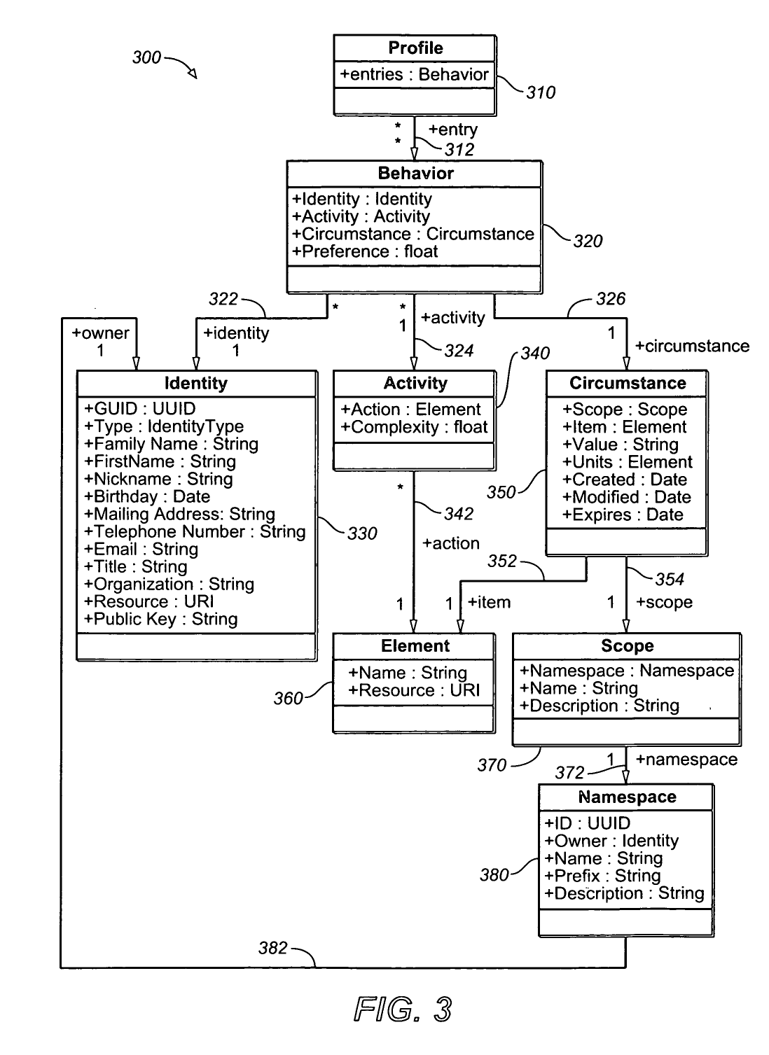

FIG. 3 illustrates one embodiment of a database structure capable of supporting persistent storage of user profiles. One of skill in the art recognizes many possible organizations and structurings exist for such a set of data and that the invention is not so limited. The particular selection of attributes (data fields) used in a particular implementation may similarly vary. The schema 300 for the Profile Data Store implementation illustrated in FIG. 3 comprises a Profile record type 310, a Behavior record type 320, an Identity record type 330, an Activity record type 340, a Circumstance record type 350, and Element record type 360, a Scope record type 370, and a Namespace record type 380. The Behavior record type 320 defines profile entries by associating the Identity, Activity, Circumstance, and Preference elements of a profile entry or sample of the preferred embodiment. Each Behavior record instance stored in the Profile Data Store represents a profile entry (sample). The Profile record type 310 is used to aggregate the Behavior entries into a profile via relation 312. The Behavior record type 320 associates the Preference profile element with the others by recording its actual value in the record itself. The remaining profile elements are associated by recording a record locator for that element, such as a key value, in the Behavior record. Data values for the Identity, Activity, and Circumstance profile elements are found using the record locator information and relations 322, 324, and 326, respectively. Each of the Activity and Circumstance record types in the preferred embodiment relates to an Element record type 360 via relations 342 and 352, respectively. Accordingly, an occurrence of an Element type record and each of its attributes may be instances of either activity or circumstance information, as the case may be, as will be readily understood by one of ordinary skill in the art. Circumstance record type 350 further relates to Scope record type 370 via relationship 354, and Scope record type 370 relates to Namespace record type 380 via relationship 372. Accordingly, an occurrence of a Scope or Namespace record, and each of their respective attributes, are each instances of circumstance information by relation as if they were immediately integral to the Circumstance record type. Namespace record type 380 similarly relates to Identity record type 330 via relationship 382. Instances of the various record types illustrated in FIG. 3 for the preferred embodiment will now be further discussed.

Profile: A profile (type 310) is a collection of behavior entries.

Behavior: A behavior record (type 320) instance is a single entry in the profile that consists of a specific association between an identity, activity, circumstance and preference. The identity, activity, and circumstance attribute instances are references to unique entities within the database, while the preference attribute is an explicit value, which is explicitly entered by the user, either in the context of the activity directly, or after the fact. The stored explicit value may, of course, be a translation, conversion, coding or interpretation of the user input action. For example, the user may indicate preference by moving a graphical slider on the display screen rather than keying in a numeric value. The user-specified position of the graphical slider is then translated into a number value within a range and stored as the preference information instance in the behavior record. Accordingly, the stored preference data is user determined.

Identity: An identity record (type 330) instance represents a unique individual or organization that interacts with the system. The attributes of identity consist of personal and organizational identification, contact information, and encryption/authentication keys.

Activity: Activity (type 340) specifies the context of user behavior. The attributes of activity consist of an element reference that uniquely specifies an action (e.g. play, learn, communicate, etc.), along with a normalized value (in the range 0.0 to 1.0) that indicates the level of social complexity in the activity (0 being most private, and 1 being most public).

Circumstance: The attributes of circumstance (type 350) describe the outcome, result, or measure of an associated activity. It is a unique quantitative measure of some concept. The attributes include a scope (identifies the source/generator of the data), an item (identifies the concept being measured), a value (the measured value), units (the unit of measure) and relevant timestamps for creation, modification and expiration.

Element: Elements (type 360) identify specific semantic concepts and associate textual syntactic names to them for query and display purposes. Each activity record refers to a unique verb concept element. Each circumstance record refers to a unique noun or adjective concept element. This mapping allows each manufacturer or service provider to assign names to profile samples, as they desire, while providing for relevancy mapping and conceptual query functions through an entire profile, across disparate scopes and namespaces.

Scope: Scope (type 370) instances represent the source or generator of circumstantial data records. This is typically a specific application or agent, i.e., a profile service requester. A scope provides a partitioning of a namespace, which is advantageously associated with a device manufacturer, service provider or application developer. Preferably, a manufacturer, developer, or provider creates a separate scope for each product or service for which profile samples are stored.

Namespace: A namespace (type 380) instance may generally be used to represent the entity/organization that is the device manufacturer, application developer or service provider responsible for the creation of specific profile data samples. Preferably, for each entity, the namespace is further broken down into specific scopes that related to specific products and services. The attribute instances of a namespace record include organization identification information, along with descriptive information and abbreviated tags, which may be used in status displays and user output.

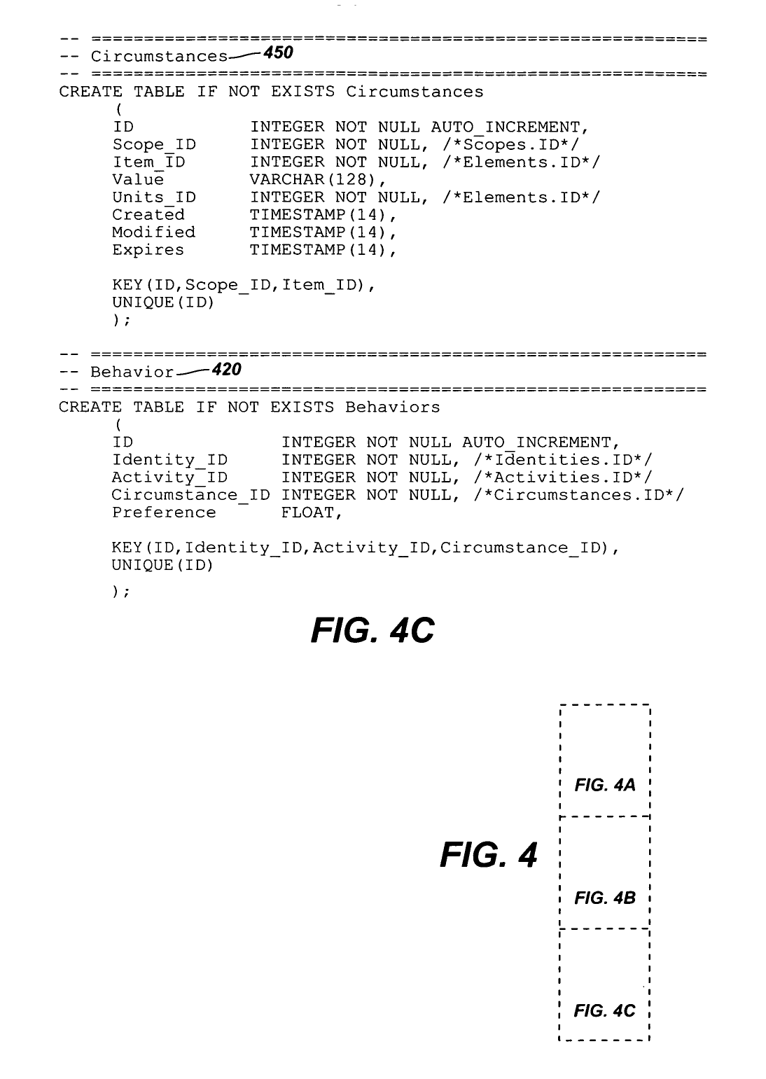

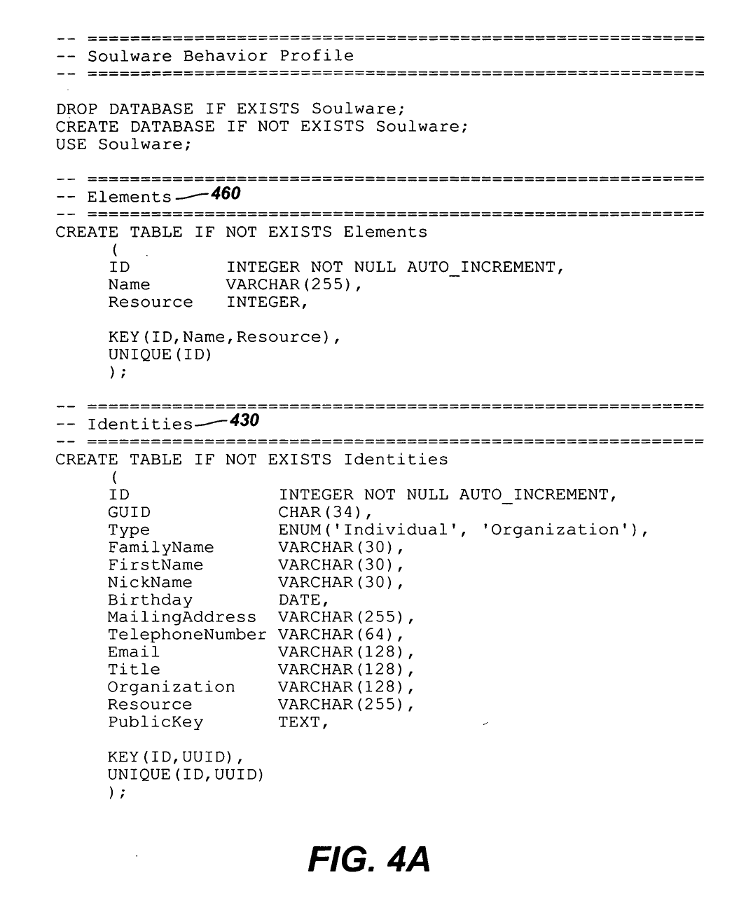

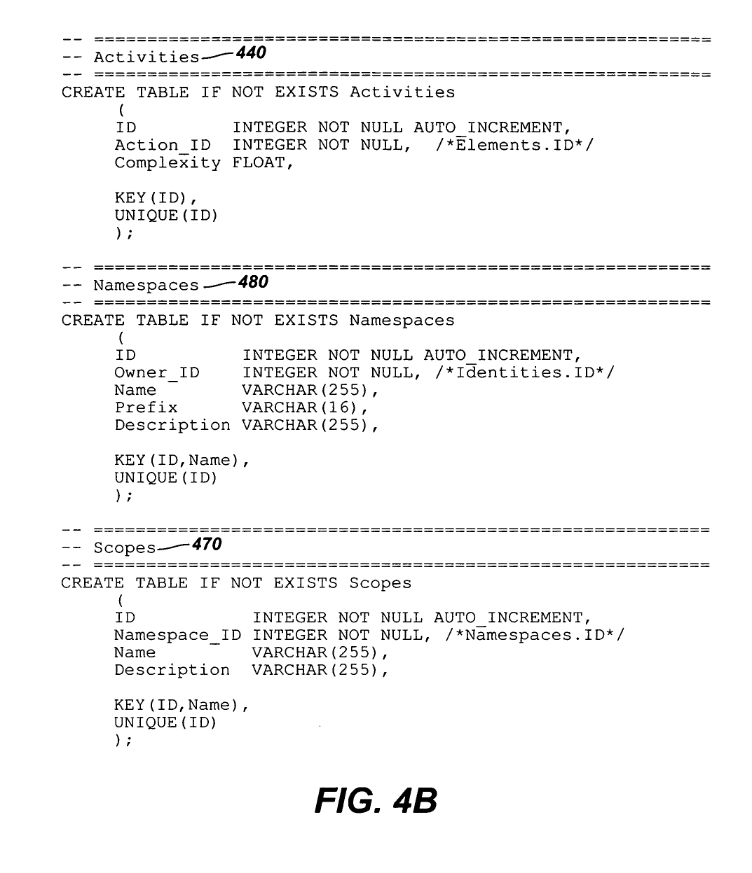

FIG. 4 depicts one possible listing of computer code for implementing the database structure of FIG. 3. The schema for the Profile Data Store is represented as SQL statements in FIG. 4.

Profile Access Manager (PAM)

The Profile Access Manager (PAM, 120 of FIG. 1) of the preferred embodiment is responsible for fulfilling all profile query and modification requests from agents. The Profile Access Manger manages all transactions with the Profile, and automatically redirects queries to the Profile Exchange Manager when the local profile cannot satisfy the request. This automatic forwarding of requests to remote devices allows requesting Agents to view the distributed profile data store as a unified database, with a single, consistent method of access, invariant to the actual location of the requested data. This distributed profile storage method is an inventive aspect of the disclosed embodiment.

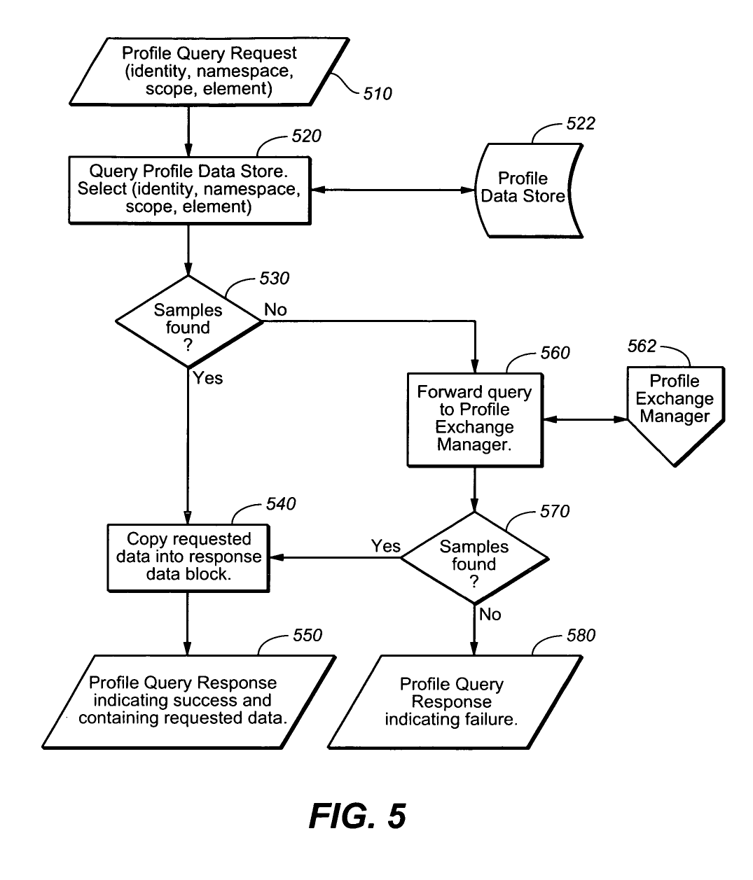

FIG. 5 is a flowchart depicting the query request handling operation of the profiling kernel in one embodiment. The flowchart describes the execution flow and logic of the Profile Access Manger when processing a profile query request. A profile query request is recognized by the PAM at 510. A query is made against the local profile data store 522 at 520 using the Profile Data Store Processor 130 of FIG. 1 and information provided by the service requester, for example, one of the agents 162-168 of FIG. 1. If satisfactory profile entry data was found as determined at 530 of FIG. 5, relevant data from the profile data store is formatted for the service requester at 540, and transferred to the service requester along with an indication of success at 550. If it is determined at 530 that no satisfactory profile entry data was found, the request may be forwarded to the Profile Exchange Manager (PEM, 140 of FIG. 1) at 560 of FIG. 5. The PEM at 562 can attempt to satisfy the profile query request from sources other than the local profile data store and return its results. If satisfactory profile entry data was found by the PEM as determined at 570, relevant data from the non-local profile data store is formatted for the service requester at 540, and transferred to the service requester along with an indication of success at 550. If it is determined at 570 that no satisfactory profile entry data was found, a response is sent to the service requester at 580 indicating failure.

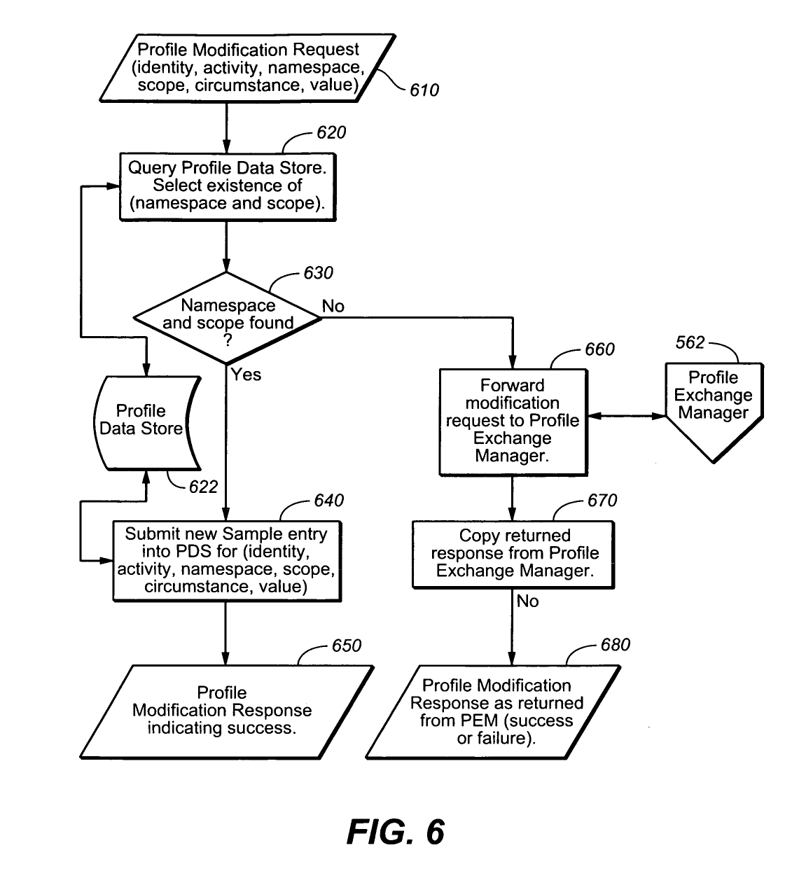

FIG. 6 is a flowchart depicting the modification request operation of the profiling kernel in one embodiment. The flowchart describes the execution flow and logic of the Profile Access Manager when processing a profile modification request to add an entry to a profile. A profile modification request is recognized by the PAM at 610. A query is made against the local profile data store 622 at 620 using the Profile Data Store Processor 130 of FIG. 1 and information provided by the service requester, for example, one of the agents 162-168 of FIG. 1. If the namespace and scope are found within the local profile data store as determined at 630 of FIG. 6, relevant data from the service requester is inserted into local profile data store 622 at 640, again using the Profile Data Store Processor 130 of FIG. 1, and the service requester is informed of the successful operation at 650 of FIG. 6. If it is determined at 630 that the local profile data store is not configured to maintain profile data for the requested namespace and scope, the request may be forwarded to the Profile Exchange Manager (PEM, 140 of FIG. 1) at 660 of FIG. 6. The PEM at 562 can attempt to satisfy the profile modification request at non-local profile data stores and return its results; i.e., the PEM can attempt to find a profile data store configured for the requested namespace and scope and insert the new profile entry there. The result returned from the PEM is copied at 670 for return to the service requester whether indicating success or not, and then returned to the requester at 680.

Profile Exchange Manager (PEM)

The Profile Exchange Manger (PEM) is responsible for all communications between devices, including for the purpose of satisfying profile requests for namespaces and scopes that are not found in the same device as the requesting agent. (In the preferred embodiment, a device has only one profile data store, and one profiling kernel operating on it.) The Profile Exchange Manager of the present embodiment communicates with Profile Exchange Managers on remote devices by exchanging messages as specified JXTA v2.0 Protocols Specification (available at http://specjxta.org/nonav/v1.0/docbook/JXTAProtocols.html and provided herein as Appendix III). Peers are discovered via the Peer Discovery Protocol (Section II,1,1.1). Connections to peers are made via the Pipe Binding Protocol (Section II,1,1.4). All messages are sent/received via the TCP/IP Message Transport (Section II,2,2.1). All message data is formatted according to the XML Message Format (Section II,3,3.3).

JXTA v2.0 Protocols Specification http://spec.jxta.org/nonav/v1.0/docbook/JXTAProtocols.html document is incorporated herein by reference.

Note that similar protocols, such as Zeroconf (available at http://www.zeroconf.org and provided herein as Appendix IV) may also be used in other embodiments to implement such functionality.

In this embodiment, when a profile request cannot be satisfied by the local profile, that request is forwarded to all peers that have been discovered in immediate proximity to the requesting device (the preferred embodiment uses no routing for improved speed and simplicity). In other embodiments, the JXTA Rendezvous Protocol may be used to control the range of propagation and routing of discovery messages, and extend the range of peers included in remote profile requests.

Profile requests that were satisfied by a remote profile, may result in a copy of that sample to be stored in the local Profile. This may occur implicitly, for caching and access optimization (network bandwidth, reduced latency) purposes, or explicitly at the discretion of Agents that need persistent (instead of transient) access to remote profile samples.

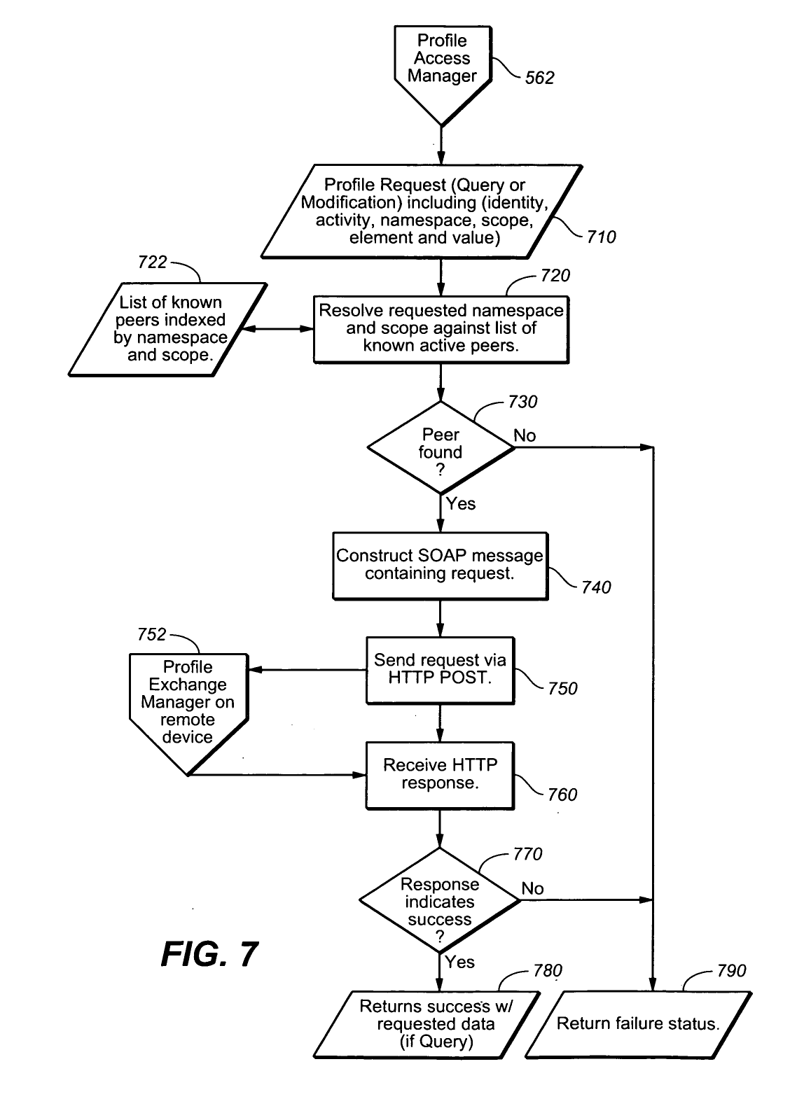

FIG. 7 is a flowchart depicting the local request handling operation of the profile exchange manager in one embodiment. The flowchart describes the execution flow and logic of the Profile Exchange Manger when processing a Profile Request (either Query or Modify) from the local Profile Access Manager. The service request is recognized at 710. A peer that may satisfy the request is identified at 720 by consulting a list of known peers and their capabilities 722. In this embodiment, a capable peer is identified by its support of a namespace and scope combination that matches the namespace and scope of the request. If it is determined that no capable peer is known at 730, a failure status is returned to the caller at 790 and PEM processing for the request ends. If it is determined that a capable peer is known at 730, a message to the peer with the request is constructed at 740. The message is sent at 750 and the response from the remote PEM 752 is awaited. When the response from the remote PEM is received at 760 a determination is made at 770 whether the response indicates success or failure. A corresponding response is then returned to the caller at 780 for success or 790 for failure, and PEM processing for the request ends.

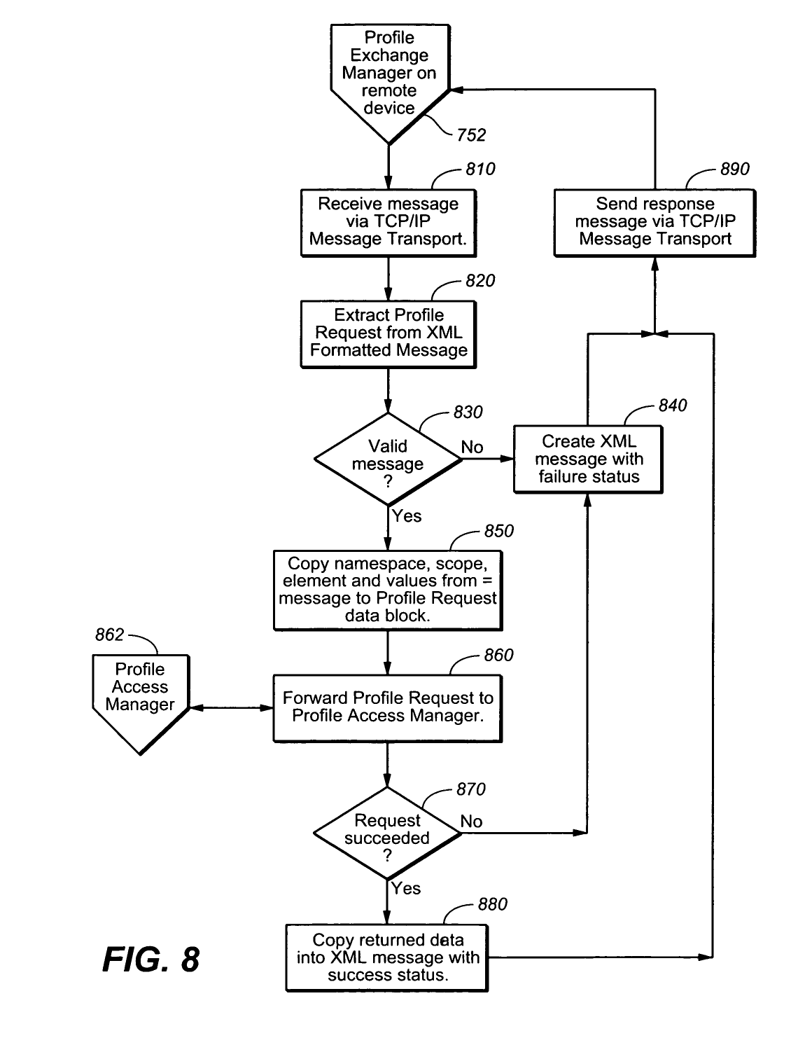

FIG. 8 is a flowchart depicting the remote request handling operation of the local profile exchange manager in one embodiment. The flowchart describes the execution flow and logic of the local Profile Exchange Manager when processing a Profile Request (either Query or Modify) from a remote Profile Exchange Manger (on a remote device). A message with a profile service request is received at 810. The request is extracted from the message at 820. If the request in the message is determined to be invalid at 830, a reply message indicating failure is constructed at 840, and sent to the originating PEM at 890, and processing for the received message stops. If the request message is determined to be valid at 830, the particulars of the request are copied and formatted at 850 for conveyance to the local PAM 862 at 860. The PAM processes the request, for example, after the fashion described earlier in relation to FIGS. 5 and 6, and returns its result to the PEM. If it is determined from the returned PAM results that the request succeeded at 870 of FIG. 8, an appropriate response is constructed at 880, and sent to the remote PEM at 890, and processing for the message stops. If it is determined from the returned PAM results that the request failed at 870, an appropriate response is constructed at 840, and sent to the remote PEM at 890, and processing for the message stops.

One skilled in the art will appreciate from the preceding text and figures, novel systems, apparatus, and methods for the storage, retrieval and exchange of personal profile data that preferably include user identity, activity, preference and circumstance data components, and for advantageously enabling consistent interpretation across multiple devices, applications and data services. One skilled in the art will also appreciate that although particular embodiments and implementation details have been disclosed to help explain the application and advantages of the invention, the invention is not limited to those particulars but rather by the claims appearing below. For example, while the preferred embodiment was discussed in relation to a laptop computer, inventive aspects can be practiced by all manner of personal electronic devices including, for example, blood glucose meters, blood pressure monitors, cell phones, and audio players, to name a few. Such devices can practice inventive aspects to enhance their own personalized interaction with the user and/or to supply profile data useful to enhance the personalized interaction of other devices. Moreover, inventive aspects are not limited to practice by devices but by data services, computer applications, and the like, similarly.

We claim:

1. An apparatus for user profile processing, comprising:
local profile data store processing logic for accessing a profile data store;
agent interface processing logic for coupling with one or more service requesters; and
access manager processing logic coupled to said local profile data store processing logic and to said agent interface processing logic to receive a profile service request via said agent interface processing logic and to exercise said local profile data store processing logic to access a profile data store in correspondence with said received profile service request wherein said access operation accesses concept identifier information of said profile data store, said concept identifier information referencable to a semantic database.

2. The apparatus of claim 1 wherein said access operation includes accessing social complexity information associated with a profile entry.

3. The apparatus of claim 1 wherein said access operation includes accessing user preference information associated with said profile entry, said preference information having a value that is a default value or a user determined value.

4. The apparatus of claim 1 further comprising:
profile exchange processing logic for processing the communication of profile related information using a data communication network; said access manager processing logic coupled to said profile exchange processing logic to exercise said profile exchange processing logic to access remote profile data in correspondence with said received profile service request.

5. The apparatus of claim 4 wherein said access operation includes accessing social complexity information associated with a profile entry.

6. The apparatus of claim 5 wherein said access operation includes accessing user preference information associated with said profile entry.

7. The apparatus of claim 6 wherein said preference information comprises a value that is a default value or a user determined value.

8. An apparatus for user profile processing, comprising:
local profile data store processing logic for accessing a profile data store;
agent interface processing logic for coupling with one or more application agents; and
access manager processing logic coupled to said local profile data store processing logic and to said agent interface processing logic to receive a profile service request via said agent interface processing logic and to exercise said local profile data store processing logic to access a profile data store in correspondence with said received profile service request wherein said access operation includes accessing information for a profile entry, said profile entry comprising identity, activity, and circumstance information.

9. The apparatus of claim 8 wherein said activity information comprises concept identifier information referencable to a semantic database.

10. The apparatus of claim 9 wherein said circumstance information comprises concept identifier information referencable to a semantic database.

11. The apparatus of claim 8 wherein said profile entry further comprises a preference information item.

12. The apparatus of claim 11 wherein said activity information comprises concept identifier information referencable to a semantic database.

13. The apparatus of claim 12 wherein said circumstance information comprises concept identifier information referencable to a semantic database.

14. A method for user profile processing, comprising:
invoking agent interface processing logic to receive a profile service request; and
invoking local profile data store processing logic to access a profile data store in correspondence with said received profile service request wherein said access operation accesses concept identifier information in said profile data store, said concept identifier information referencable to a semantic database.

15. The method of claim 14 wherein said access operation includes accessing social complexity information associated with a profile entry.

16. The method of claim 14 wherein said access operation includes accessing user preference information associated with said profile entry, said preference information having a value that is a default value or a user determined value.

17. The method of claim 14 further comprising:
invoking profile exchange processing logic to process the communication of profile related information using a data communication network, wherein said communication of profile related information includes information to access remote profile data in correspondence with said received profile inquiry request.

18. A method for maintaining a user profile database, comprising:
storing an identity information instance related to a user associated with a profile;
storing an activity information instance related to an action associated with a user;
storing a circumstance information instance related to a result associated with an activity;
representing in storage the association of said user identity information instance, said activity information instance, and said circumstance information instance as a profile entry instance; and
wherein at least one of said activity information instance and said circumstance information instance comprise concept identifier information referencable to a semantic database.

19. The method of claim 18 further comprising:
storing a preference information item instance related to a user preference; and
associating said preference information item instance with said profile entry instance.

20. The method of claim 19 wherein the value of said preference information item instance corresponds to a default value or a user-determined value.
